(19) United States
(12) Patent Application Publication
(10) Pub. No.: US 2020/0304513 A1
(43) Pub. Date: Sep. 24, 2020

(54) METHOD AND APPARATUS FOR NETWORK ACCESS CONTROL

(71) Applicant: INTERDIGITAL CE PATENT HOLDINGS, Paris (FR)

(72) Inventors: Brian Charles ERIKSSON, San Jose, CA (US); Ajith PUDHIYAVEETIL, Palo Alto, CA (US); Yifan SUN, Mountain View, CA (US)

(21) Appl. No.: 16/618,791

(22) PCT Filed: May 31, 2018
(86) PCT No.: PCT/EP2018/064379

§ 371 Date: Dec. 2, 2019

Related U.S. Application Data
(60) Provisional application No. 62/514,144, filed on Jun. 2, 2017.

(51) Int. Cl. H04L 29/06

(52) U.S. Cl. CPC H04L 63/107; H04L 63/08; H04L 63/102

(57) ABSTRACT

A method (400) of generating guest accounts in a local area network is provided including determining (410) a presence of at least one user in a premises and generating (420) at least one guest account in a local area network established in the premises based on the determined presence. An apparatus (101, 102, 300) for generating guest accounts in a local area network is provided, the apparatus including a processor (304), and at least one memory (312) coupled with the processor, the processor being configured to determine a presence of at least one user in a premises and generate at least one guest account in a local area network (150) established in the premises based on the determined presence. A computer-readable storage medium and a non-transitory computer-readable program product are also described.

### TECHNICAL FIELD

The present disclosure relates to network access control and, particularly, to creating accounts in local area networks.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

Unlike networks of the past, today's local area networks (e.g., home and office networks) can distribute audio, video and data from one device to another, and can also support interactive dialogues between devices or between a device and the Internet. In particular, the advancement of low cost short range wireless communications has allowed many services to evolve and new services to be created within the home and office environment. The traditional personal computer (PC), mobile and consumer electronics (CE) domains are coming together and creating a melting pot of new interactive applications and interactive appliances, the internet of things (IOT) devices, blurring the boundaries of these traditional domains. More and more, people feel the need to be connected to the internet anytime, anywhere. Guests to a home may want to be able to connect without the burden of pre-registering their devices. On the other hand, members of a local area network, e.g., home owners, may have concerns about security.

Therefore, there is a need to identify flexible yet secure techniques to permit access to local area networks by people who are not members of the network and devices that are not registered in the network. The present disclosure is directed towards such a technique.

### SUMMARY

According to an aspect of the present disclosure, a method is provided including determining a presence of at least one user in a premises and generating at least one guest account in a local area network established in the premises based on the determined presence.

According to an aspect of the present disclosure, an apparatus is described, the apparatus including a processor, and at least one memory coupled with the processor, the processor being configured to determine a presence of at least one user in a premises and generate at least one guest account in a local area network established in the premises based on the determined presence.

According to an aspect of the present disclosure, a non-transitory computer-readable program product is provided including program code instructions for performing any of the embodiments of the method described above.

According to an aspect of the present disclosure, a computer-readable storage medium carrying a software program is provided including program code instructions for performing any of the embodiments of the method described above.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

Additional features and advantages of the present disclosure will be made apparent from the following detailed description of illustrative embodiments which proceeds with reference to the accompanying figures.

### BRIEF DESCRIPTION OF THE DRAWINGS

The present disclosure may be better understood in accordance with the following exemplary figures briefly described below:

FIG. 1 illustrates a block diagram of an exemplary content distribution and communication network system in accordance with an embodiment of the present disclosure;

FIG. 2 illustrates a block diagram of an exemplary content distribution and communication network system within a home or office premises in accordance with an embodiment of the present disclosure;

FIG. 3 illustrates a block diagram of an exemplary network device in accordance with an embodiment of the present disclosure;

FIG. 4 illustrates a flowchart of an exemplary method of providing multimedia content in accordance with an embodiment of the present disclosure; and

FIG. 5 illustrates a block diagram of a computing environment within which aspects of the present disclosure can be implemented and executed.

### DETAILED DISCUSSION OF THE EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present disclosure is directed to techniques for network access control and, particularly, to creating accounts in local area networks for guests e.g., to a home or office. The guests may want to be able to connect without the burden of pre-registering their devices. On the other hand, members of a local area network, e.g., home owners, may have concerns about security. Identifying known users and unknown or guest users is critical for digital safety in local area networks. According to the present disclosure, the gateway protection in the local area network is enhanced by using a plurality of indoor sensors to detect the presence or absence of a known user(s) or guest user(s) in the premises, e.g., a home or office. The system can automatically detect the presence/absence of users and automatically adjust the gateway safety levels. In particular, the system can automatically generate/enable/activate or disable/inactivate guest accounts based on the detected presence/absence of known users and/or guests.

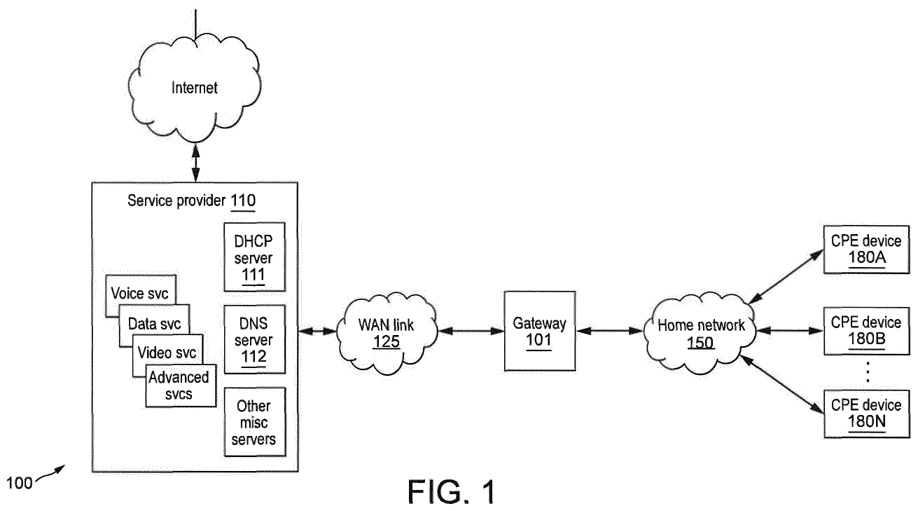

Turning to FIG. 1, a block diagram of an exemplary arrangement for a content distribution and communication network system 100 in accordance with an embodiment of the present disclosure is shown. According to an exemplary embodiment, gateway 101 is an advanced cable gateway, cable modem, DSL (Digital Subscriber Line) modem or the like, and is coupled to a wide area network (WAN) link 125 through a WAN interface to service provider 110. Service provider 110 may represent one or more service providers combined. The WAN link 125 may be any one or more of the possible communication links including, but not limited to, coaxial cable, fiber optic cable, telephone line, or over the air links. The gateway 101 is also coupled via a local area network (LAN) interface to home network 150 which couples one or more customer premises equipment (CPE) devices 180A-N. The home network 150 preferably includes a wireless link but may also include wired links such as coaxial cable or Ethernet. CPE devices 180A-N may include, for example, personal computers, network printers, digital set-top boxes, landline phones, cell/smart phones, internet of things (IOT) devices, sensors, and/or audio/visual media servers and players, among others.

Service provider 110 provides one or more services, such as voice, data, video and/or various advanced services (e.g., IOT services like security, temperature control, etc.), over WAN link 125 to CPE devices 180A-N through gateway 101 and home network 150. Service provider 110 may include Internet related services and server structures such as a Dynamic Host Configuration Protocol (DHCP) server 111 and Domain Name System (DNS) server 112, and may include other servers and services as well (e.g., video on demand, news, weather). It is important to note that these servers and services can be co-located or widely distributed, physically and/or virtually, in both hardware and software. It is contemplated that service provider 110 operates in a conventional manner in accordance with well-known protocols (e.g., Data Over Cable Service Interface Specification, DOCSIS). In an illustrative cable application, service provider 110 may be, for example, a cable multiple service operator (MSO).

Gateway 101 acts as the interface between the WAN link 125 external to the customer's home/office and the home/office network 150 located in the customer's home/office. Gateway 101 converts transport data packets, such as packets in an IP protocol, from a format used in the WAN to a format used in the home network or LAN. Gateway 101 also routes data packets, including the converted data packets between the WAN and one or more devices on the home network. Gateway 101 may include interfaces for both wired networking (e.g., Ethernet Multimedia over Cable Alliance (MoCA)) and wireless networking. Gateway 101 allows data, voice, video and audio communication between the WAN and CPE devices 180A-N used in the customer's home, such as analog telephones, televisions, computers, and the like.

It is important to note that in some configurations, the gateway 101 may be partitioned into two separate devices coupled together in some communicative manner. The first device, connected to the WAN portion of the system, may be referred to as a cable modem or network termination device (NTD). The second device, connected to the home LAN portion of the system, may be referred to as a home router, a home server, or a home gateway. Functionally, and as will be described below, the two devices operate in a manner consistent with gateway 101.

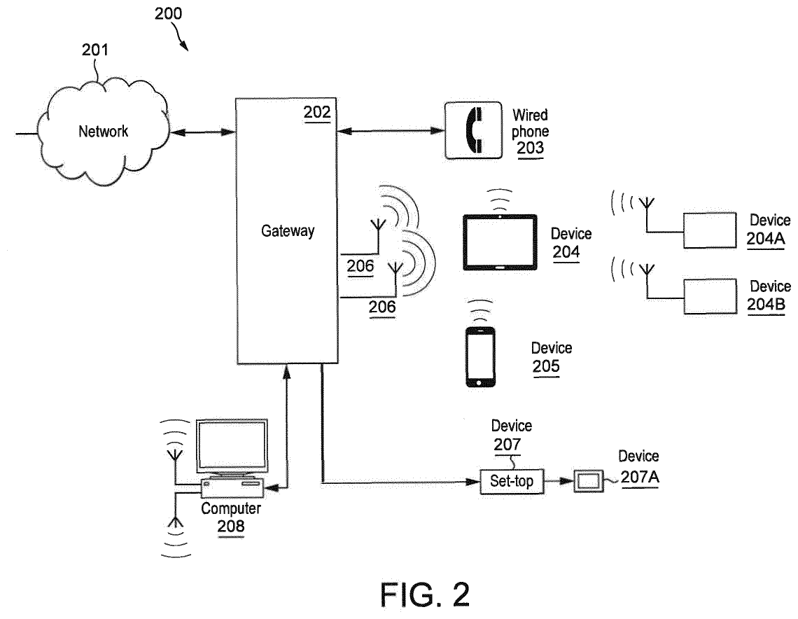

FIG. 2, shows a gateway system 200 according to aspects of the present disclosure. Gateway system 200 operates in a manner similar to networking communication system 100 described in FIG. 1. In gateway system 200, network 201 similar to WAN 125 is coupled to gateway 202, which is similar to gateway 101. Gateway 202 connects to a wired phone 203. Gateway 202 also connects to computer 208 by wired means, e.g., Ethernet cable. In addition, gateway 202 interfaces with devices 204 and 205 through a wireless interface using one or more antennas 206. Device 204 may also connect to other devices by wireless means. Gateway 202 may also connect to devices 204 and 205 by wired means, e.g., Ethernet or coaxial cable. Similarly, devices 204A and 204B may also connected to device 204 or to Gateway 202 by wired means, e.g., Ethernet or coaxial cable. Gateway 202 may also interface with computer 208 using the one or more antennas 206. Gateway 202 may be connected to set-top device 207 by Ethernet or coaxial cable (as shown) or by wireless means. Set-top 207 may be connected to a television 207A also by cable (as shown) or by wireless means. Devices 203, 204, 205 and 207 connected to gateway 202 may be consumer electronics devices, e.g., a television, a set-top box, a clock radio, a Compact Disk (CD) player, DVD player, a Videocassette Recorder (VCR), a Digital Video Recorder (DVR), refrigerator, washing machine, dishwasher, etc. Devices 204, 205 may also be control devices for various services, e.g., home security, home temperature control or thermostat, home fire alarm, home appliance control, home energy control (e.g., lighting), etc. Devices 204 and 205 may also connect (wirelessly or not) to yet other devices, 204A, 204B, that are necessary for the particular service that they provide, e.g., keypads, sensors, cameras, remote controls. In one example, devices 204A and 204B may be camera/door/window sensors controlled by security controller 204.

In particular, gateway system 200 operates as part of a cable network interface and acts to interface a packet data cable system to one or more home networks. Gateway system 200 includes gateway 202 that provides the interface between the network 201, operating as a WAN, and the home network(s). Gateway system 200 also includes wired analog telephone device 203 capable of operating as a home telephone when connected through gateway 202. In addition, gateway 202 also acts to provide a radio frequency (RF) interface to multiple wireless devices 204 and 205. Wireless devices 204 and 205 may be handheld devices that operate using wireless packet transmissions via one or more antennas 206 on gateway 202. Wireless devices 204A and 204B may also be devices that are not handheld and that are mounted on walls or placed in different rooms of the home (not shown). For example, it is commonplace to mount a control device for a home security system on a wall. In other embodiments, other devices with wireless interfaces including, but not limited to routers, tablets, set-top boxes, televisions, media players and home appliances may be used.

The wireless interface included in gateway 202 may also accommodate one or more wireless formats including Wi-Fi, Institute of Electrical and Electronics Engineers standard IEEE 802.11, Bluetooth or other similar wireless communication protocols. Further, it is important to note that each antenna in the system may be attached to a separate transceiver circuit. As shown in FIG. 2, gateway 202 includes several transceivers or transmit/receive circuits and two antennas. Device 204 and computer 208 include two transceiver circuits and two antennas while device 205 only one transmit/receive circuit and one antenna. Device 207 includes one transmit/receive circuit. In some alternate designs, it may be possible that more than one antenna may be included with, and used by, a single transceiver circuit.

In operation, gateway 202 may provide Internet protocol (IP) services (e.g., data, voice, video, and/or audio) between devices 204A-B and Internet destinations identified and connected via network 201. Gateway 202 may also provide IP voice services between wired phone 203 and call destinations routed through network 201. Gateway 202 may also provide other services between service provider (e.g., 110) and control devices 204, 205, 207 for the services, e.g., home security, home temperature control or thermostat, home fire alarm, home appliance control, home energy control, etc. Gateway 202 may further provide connectivity to a local computer 208 either via a wired connection such as is shown in FIG. 2 or via a wireless connection through one or more antennas and transceiver circuits. Thus, example interfaces for computer 208 include Ethernet, IEEE 802.11 and Bluetooth. As noted above, gateway 202 may physically be configured as two components, a cable modem or NTD that connects to network 201 and a home gateway that connects to all other devices in the home.

Gateway 202 further includes a communication front end circuit for interfacing with the headend or CMTS through the network 201. In some embodiments, the gateway 202 further includes circuitry for communicating in the home network or LAN using MoCA protocols over a co-axial cable. The communication front end circuit may include a diplexer filter, or a triplexer filter if MoCA is included, for separating the upstream communication and downstream communication signals (as well as MoCA signals if present).

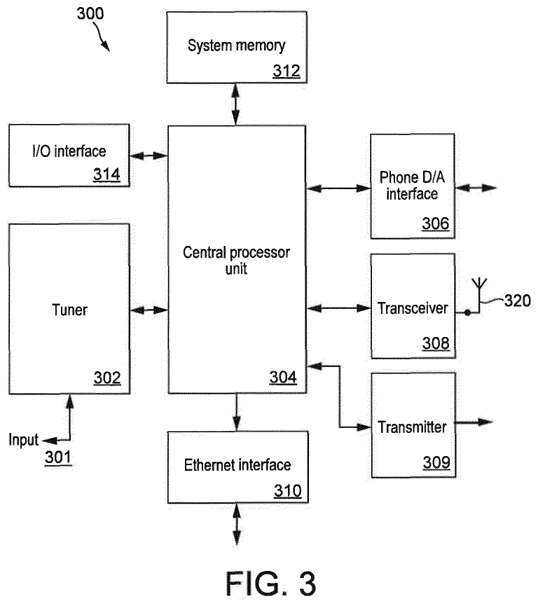

Turning to FIG. 3, a block diagram of an exemplary gateway device 300 according to aspects of the present disclosure is shown. Gateway device 300 may be similar to gateway 202 described in FIG. 2 or to gateway 101 described in FIG. 1 but not including the same components. In gateway device 300, an input signal is provided to RF input 301. RF input 301 connects to tuner 302. Tuner 302 connects to central processor unit 304. Central processor unit (CPU) 304 connects to phone D/A (digital to analog) interface 306, transceiver 308, transmitter 309, Ethernet interface 310, system memory 312, and input/output (IO) interface 314. Transceiver 308 further connects to antenna 320. It is important to note that several components and interconnections necessary for complete operation of gateway device 300 are not shown in the interest of conciseness, as the components not shown are well known to those skilled in the art. Gateway device 300 may be capable of operating as an interface to a cable communication network, to a DSL network and to over the air networks, e.g., cellular telephone, satellite, etc., and further may be capable of providing an interface to one or more devices connected through either a wired and wireless home network. For bi-directional communication networks (e.g., cable, DSL, cellular telephone, wireless, etc.), tuner component 302 would further include an upstream transmitter for communication with the service provider. In other communication networks (e.g., satellite), upstream communication with the service provider may be performed by a separate network (e.g., landline or cellular telephone).

A signal, such as a cable signal on the WAN, is interfaced to tuner 302 through RF input 301. Tuner 302 may perform RF modulation functions on a signal provided to the WAN and demodulation functions on a signal received from the WAN. The RF modulation and demodulation functions are the same as those commonly used in communication systems, such as cable systems. Central processor unit or processor 304 accepts the demodulated cable signals and digitally processes the signal from tuner 302 to provide voice signals and data for the interfaces in gateway 300. Similarly, central processor unit 304 also processes and directs any voice signals and data received from any of the interfaces in gateway 300 for delivery to tuner 302 and transmission to the WAN. Processor 304 may also perform additional processing according to embodiments of the present disclosure as further described below.

System memory 312 supports the processing and IP functions in central processor unit 304 and also serves as storage for program and data information. A portion of system memory 312 is a non-transitory computer readable medium having stored thereon instructions of program code for executing methods when the program code is executed on a computer. Processed and/or stored digital data from central processor unit 304 is available for transfer to and from Ethernet interface 310. Ethernet interface may support a typical Registered Jack type RJ-45 physical interface connector or other standard interface connector and allow connection to an external local computer. Processed and/or stored digital data from central processor unit 304 is also available for digital to analog conversion in interface 306. Interface 306 allows connection to an analog telephone handset. Typically, this physical connection is provided via an RJ-11 standard interface, but other interface standards may be used. Processed and/or stored digital data from central processor unit 304 is additionally available for exchange with transceiver 308 and transmitter 309. Transceiver 308 and transmitter 309 can both support multiple operations and networked devices simultaneously. Transceiver 308 may support wireless communications with, e.g., devices 204 and 205 in FIG. 2. Antenna 320 connected to transceiver 308 is similar to antennas 206. Transmitter 309 may support broadcast cable television, e.g., as shown by devices 207 and 207A in FIG. 2. Central processor unit 304 is also operative or configured to receive and process user input signals provided via I/O interface 314, which may include connections to a display, sensors and/or a user input device such as a hand-held remote control, keyboard and/or other type of user input device.

As noted above, the gateway device 300 may be configured to operate as an NTD. In this case, central processing unit 304 may only connect to tuner 302, Ethernet interface 310, and system memory 312. Phone D/A interface 306, transceiver 308 and/or transceiver 309 may not be present or used. Further, an NTD may not include a direct user interface and as such may not include I/O interface 314. Additionally, the NTD may include and support more than one Ethernet interface 310 and may be capable operating each Ethernet interface as a separate virtual circuit between the content service provider(s) and the home gateway attached to the Ethernet interface, thus allowing the creation of separate LANs for each content consumer.

The presence/absence of a user in a premises (e.g., home, office) is one of the most relevant and important factors in recognizing unauthorized access to the LAN(s) 150 in the premises through the premises gateway 101, 202, 300. In the following, references to gateway access/connection and access/connection to a LAN will be exchangeable, since the gateway controls the access to the LAN. Also, the gateway device may just operate as a router when the WAN 125, 201 and LAN 150 are similar networks.

In the following, a known user is one known to be authorized to access a LAN in the premises through the gateway, e.g., home owner(s), office worker(s). The known user has been previously authorized by the plurality of sensors and/or by pre-registration of their devices with the gateway. A device that has been pre-registered by the gateway is assumed to belong to a known user. Unknown or guest users are users that are not recognized by the plurality of sensors in the premises and/or whose devices are not pre-registered. Devices that are not pre-registered are assumed to belong to unknown users.

In the following, no distinction is made between an intruder and an actual guest of the known users: all unrecognized users are unknown users. However, the presence of a known user in the premises is key to distinguishing appropriate actions by the network access control. For example, if no known user is present in the premises, an unknown user is likely to be an intruder. And if a known user is present, the unknown user is more likely to be an actual guest. So, the creation of guest accounts is based on the presence/absence of known users. Hence, if a known user is not in the premises, a connection request to the gateway is more likely to be suspicious to the gateway. Guest Wi-Fi and other vulnerable accesses to a gateway can be safely managed if the presence of a user(s) can be automatically and accurately estimated.

In one embodiment, a known/unknown user may exclude certain people, e.g., young children below a certain age, senior citizens above a certain age, unknown people at certain hours of the day (e.g., handy man, cleaning person, etc.). In one embodiment, the system settings for excluding certain people from being a user may be chosen by a known user(s), e.g., establishing hours of the day, establishing days of the week, establishing size/age limits, etc.

Estimating/determining the presence of a user at home using a single sensor may be difficult due to the complexity of the home environment and variability in in-premises activities. Hence, a plurality of sensors may be used but not necessary. The plurality of sensors used to detect the presence/absence of users include at least one of camera(s), microphone(s), motion sensor(s), door sensor(s), window sensor(s), face/palm/finger/eye/signature recognition sensors(s), etc. In one embodiment, the sensors (e.g., 180A-N, 204A-B, etc.) may be connected to the gateway by wired or wireless means. The sensors may be directly connected to the gateway (e.g., CPE 180A-N) and transmit their data for processing and determination of presence/absence of known/unknown users.

In one embodiment, the sensors (e.g., 204A-B) may be connected to a controller device (e.g., 204) which is connected to the gateway. The controller device (e.g., 204) may process the sensor data in order to determine/detect the presence/absence of known/unknown user(s). Or the controller device (e.g., 204) may just gather the data from at least one sensor and transmit the data to the gateway 101, 202, 300 for processing and determination of presence/absence of users.

In one embodiment of the present disclosure, the correlation of different measurements from the plurality of sensors may be exploited by any techniques well known in the art of recognition, including face, iris, hand, finger, body shape/size, etc. For example, sensors may detect the particular features of people as they enter the premises or as they enter one of the rooms in the premises. In one embodiment, the correlation may be performed by machine learning techniques, specifically, by a classification and decision model used to perform adaptive prediction. The classification and decision model may be integrated with the gateway 101, 202, 300 or to the controller device (e.g., 204) depending on which device processes the data. The model may have default thresholds for some identifications (e.g., motion sensor, door sensor, window sensor, etc.), but may also be trained locally using only the private data due to the uniqueness of the configurations of each premises (e.g., vide/pictures, voice, work hours of known users (e.g., home owners, office workers, etc.). A training phase may be required for each premises or user, but may not require explicit labels. The presence of user's personal mobile device may also be used as the training labels and train the standard classification model at the beginning stage. The model may be automatically re-trained if the configuration of the sensors is changed (e.g., the location of a camera is changed, a new sensor is connected into the system, etc.).

In one embodiment, when no known user is in the premises, no guest accounts are created. Otherwise, when at least one known user is in the premises, guest accounts are allowed.

In one embodiment, the number of guest accounts may be determined by a known user, e.g., set via a user interface. The number of guest accounts may be based on the number of unknown users detected in the premises by the various sensors. For example, if two unknown users are detected inside the premises then the system allows for two guest connections to the LAN; if there is a party in the premises with six unknown users detected, then a maximum of six guest connections are allowed to the LAN.

In one embodiment, a guest account is an unsecure guest account. In one embodiment, a guest account is password protected. By protecting the guest accounts with password(s), security is increased, since persons outside the premises (e.g., neighbors) cannot access the guest accounts. The password may be established in the system settings by a known user. In one embodiment, all guest accounts have the same password.

Known users are always allowed a connection to the LAN through their known devices, which are already known/pre-registered/authorized by the gateway. Any pre-registered devices are understood to be known devices, that is, belonging to a known user. Unknown devices are not known/registered by the gateway.

In one embodiment, any known device, i.e., a device that is pre-registered or known by the gateway, may connect to the gateway regardless of the user. For example, if an unknown user is using a device that belongs to a known user, the device may connect to the gateway, even if no known user is in the premises.

In one embodiment, any known device may connect to the gateway as long as at least one known user is in the premises. For example, if an unknown user is using a device that belongs to a known user and a known user is present in the premises, the device may connect to the gateway.

In one embodiment, no known device may connect to the gateway if no known user is present in the premises. For example, if an unknown user is using a device that belongs to a known user and no known users are present in the premises, then the device cannot connect to the gateway.

In one embodiment, if a known or unknown user is using a device that does not belong to a known user, hence, it hasn't been pre-registered in the gateway, the device connects to the gateway if it uses a known password to connect to the gateway. In one embodiment, if a known or unknown user is using a device that does not belong to a known user, the device connects to the gateway if an unsecure guest account has been created by the system.

In one embodiment, in order to give the known user (e.g., home owner) prompt notification of unauthorized access and risky attack to the gateway, the system may also provide a notification. The system may notify the known user if he/she is not in the premises when an unauthorized device attempts to access. The system may also notify the known user if no known users are in the premises when an authorized/pre-registered device attempts to access. The notification to known users may be done through text messages, smart phone notification, etc.

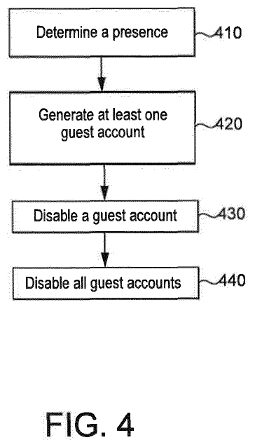

FIG. 4 illustrates a flowchart 400 of an exemplary method of generating at least one guest account in a local area network in accordance with one embodiment of the present disclosure. The method 400 includes, at step 410, determining a presence of at least one user in a premises. Then, at step 420, the method includes generating at least one guest account in a local area network established in the premises based on the determined presence. The steps of determining 410 and generating 420 may be performed, e.g., by gateway 101, 202, 300, in particular, by central processor unit or processor 304. The premises may be, e.g., a home or office. In one embodiment, the step of determining 410 may be performed by a device other than a gateway, e.g., devices 180A-N, 204, 204A-B, 205, 208 and 500, and the determination be sent to the gateway. The local area network may be a home or office network, e.g., 150.

According to one embodiment of the method, the at least one guest account is generated when the at least one user is present in the premises, the at least one user including at least one known user.

According to one embodiment of the method, at least one guest account is generated when the at least one user further includes at least one guest user, a guest user being a user other than a known user.

According to one embodiment of the method, a number of the at least one guest account is based on a number of at least one guest user detected in the premises.

According to one embodiment, the method further includes, at step 430, disabling a guest account when a guest user leaves the premises. In one embodiment, step 430 may be performed by a gateway, e.g., gateway 101, 202 and 300.

According to one embodiment, the method further includes, at step 440, disabling all guest accounts when all known users leave the premises.

According to one embodiment of the method, the at least one guest account permits connection of a guest device to the local area network without prior registration or authentication.

According to one embodiment of the method, the determining a presence further includes receiving sensor data from at least one sensor and detecting a presence based on the sensor data.

According to one embodiment of the method, the determining a presence further includes detecting at least one known user device being active in the local area network.

It is to be understood that any of the embodiments of the method 400 described above may be implemented by the gateway device 101, 202 or 300 (particularly processor 304).

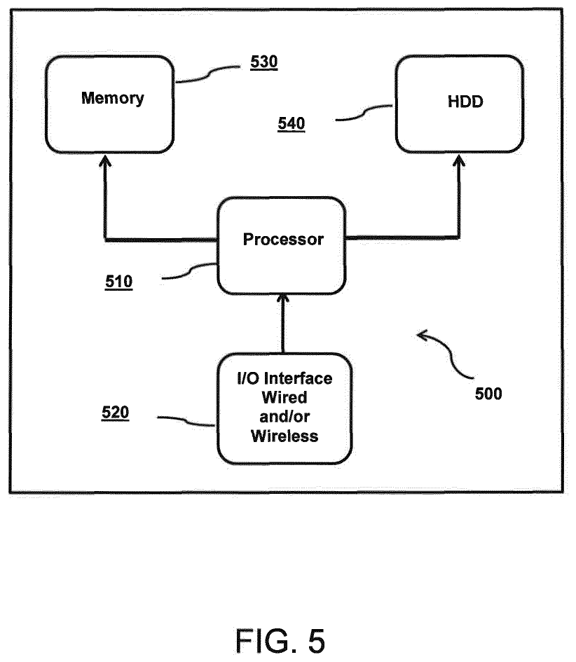

In addition, some of the steps of the method 400 described above (e.g., step 410 and its corresponding embodiments) may be implemented and executed by a computing system other than gateway 101, 202, 300 as described in FIG. 5. The computing system may be a device connected to gateway 101, 202, 302 by wired or wireless means (e.g., devices 180-A-N, 204, 205, 207, 208) and provide data to gateway 101, 202, 302. FIG. 5 illustrates a block diagram of an exemplary computing environment 500 according to an aspect of the present disclosure. The computing environment 500 includes a processor 510, and at least one (and preferably more than one) I/O interface 520. The I/O interface 520 can be wired or wireless and, in the wireless implementation is pre-configured with the appropriate wireless communication protocols to allow the computing environment 500 to operate on a global network (e.g., internet) and communicate with other computers or servers (e.g., cloud based computing or storage servers) so as to enable the present disclosure to be provided, for example, as a Software as a Service (SAAS) feature remotely provided to end users. One or more memories 530 and/or storage devices (Hard Disk Drive, HDD) 540 are also provided within the computing environment 500. The computing environment may be used to implement a node or device, and/or a controller or server that operates the storage system. The computing environment may be, but is not limited to, desktop computers, cellular phones, smart phones, phone watches, tablet computers, personal digital assistant (PDA), netbooks, laptop computers, set-top boxes or general multimedia content receiver and/or transmitter devices.

According to an aspect of the present disclosure, an apparatus 101, 200, 300 for generating at least one guest account in a local area network comprising a processor and at least one memory 312 coupled to the processor 304, the processor 304 configured to perform the method according to any of the embodiments previously described. The apparatus 101, 200, 300 may be one of a gateway device and a router device.

According to an aspect of the present disclosure, an apparatus 101, 200, 300 for generating at least one guest account in a local area network 150 comprising a processor and at least one memory 312 coupled to the processor 304, the processor 304 configured to determine a presence of at least one user in a premises and generate at least one guest account in a local area network established in the premises based on the determined presence.

According to one embodiment of the apparatus 101, 200, 300, the at least one guest account is generated when the at least one user is present in the premises, the at least one user including at least one known user.

According to one embodiment of the apparatus 101, 200, 300, at least one guest account is generated when the at least one user further includes at least one guest user, a guest user being a user other than a known user.

According to one embodiment of the apparatus 101, 200, 300, a number of the at least one guest account is based on a number of at least one guest user detected in the premises.

According to one embodiment of the apparatus 101, 200, 300, the processor 304 is further configured to disable a guest account when a guest user leaves the premises.

According to one embodiment of the apparatus 101, 200, 300, the processor 304 is further configured to disable all guest accounts when all known users leave the premises.

According to one embodiment of the apparatus 101, 200, 300, the at least one guest account permits connection of a guest device to the local area network without prior registration or authentication.

According to one embodiment of the apparatus 101, 200, 300, the processor 304 is further configured to receive sensor data from at least one sensor and detects a presence based on the sensor data.

According to one embodiment of the apparatus, the processor 304 is further configured to detect at least one known user device being active in the local area network.

According to one embodiment processor 510 is configured to receive sensor data from at least one sensor, detect a presence based on the sensor data and send detected presence to the apparatus 101, 202, 300. Hence, in this embodiment of the apparatus 101, 202, 300, the processor 304 is further configured to receive the determined presence, instead of determining a presence.

Moreover, method 400 may be implemented as a computer program product comprising computer executable instructions which may be executed by a processor. The computer program product having the computer-executable instructions may be stored in the respective non-transitory computer-readable storage media of the respective above mentioned device(s).

According to an aspect of the present disclosure, a non-transitory computer-readable program product is provided including program code instructions for performing any of the embodiments of the method 400 of generating at least one guest account in a local area network.

It is important to note that one or more of the elements in the process 400 may be combined, performed in a different order, or excluded in some embodiments while still implementing the aspects of the present disclosure. For example, in one embodiment of the method 400, steps 430 and 440 may be performed simultaneously or may be reversed in order.

Furthermore, aspects of the present disclosure can take the form of a computer-readable storage medium. Any combination of one or more computer-readable storage medium(s) may be utilized. A computer-readable storage medium can take the form of a computer-readable program product embodied in one or more computer-readable medium(s) and having computer-readable program code embodied thereon that is executable by a computer. A computer-readable storage medium as used herein is considered a non-transitory storage medium given the inherent capability to store the information therein as well as the inherent capability to provide retrieval of the information therefrom. A computer-readable storage medium may be, for example, but is not limited to, an electronic, magnetic, optical, electromagnetic, infrared, or semiconductor system, apparatus, or device, or any suitable combination of the foregoing.

It is to be appreciated that the following list, while providing more specific examples of computer-readable storage mediums to which the present disclosure may be applied, is merely an illustrative and not exhaustive listing as is readily appreciated by one of ordinary skill in the art. The list of examples includes a portable computer diskette, a hard disk, a read-only memory (ROM), an erasable programmable read-only memory (EPROM or Flash memory), a portable compact disc read-only memory (CD-ROM), an optical storage device, a magnetic storage device, or any suitable combination of the foregoing.

According to an aspect of the present disclosure, a computer-readable storage medium carrying a software program is provided including program code instructions for performing any of the embodiments of the method 400 of generating at least one guest accounts in a local area network.

It is to be appreciated that the various features shown and described are interchangeable. Unless otherwise indicated, a feature shown in one embodiment may be incorporated into another embodiment. Further, the features described in the various embodiments may be combined or separated unless otherwise indicated as inseparable or not combinable.

As noted before, the functions of the various elements shown in the figures may be provided through the use of dedicated hardware as well as hardware capable of executing software in association with appropriate software. Also, when provided by a processor, the functions may be provided by a single dedicated processor, by a single shared processor, or by a plurality of individual processors, some of which may be shared.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope of the present disclosure. In addition, individual embodiments can be combined, without departing from the scope of the present disclosure. All such changes and modifications are intended to be included within the scope of the present disclosure as set forth in the appended claims.

1. A method comprising:
determining, based on sensor data received from at least one sensor, a presence of at least one known user and at least one guest user in a premises, wherein a known user has been previously authorized by the at least one sensor and a guest user is not recognized by the at least one sensor; and
generating at least one guest account in a local area network established in said premises based on said determined presence.

2-3. (canceled)

4. The method according to claim 1 wherein a number of the at least one guest account is based on a number of at least one guest user detected in the premises.

5. The method according to claim 1 further comprising:
disabling a guest account when a guest user leaves the premises.

6. The method according to claim 1 further comprising:
disabling all guest accounts when all known users leave the premises.

7. The method according to claim 1 wherein said at least one guest account permits connection of a guest device to the local area network without prior registration or authentication.

8-9. (canceled)

10. An apparatus comprising a processor and at least one memory coupled to the processor, the processor configured to:
determine, based on sensor data received from at least one sensor, a presence of at least one known user and at least one guest user in a premises, wherein a known user has been previously authorized by the at least one sensor and a guest user is not recognized by the at least one sensor; and
generate at least one guest account in a local area network established in said premises based on said determined presence.

11-12. (canceled)

13. The apparatus according to claim 10, wherein a number of the at least one guest account is based on a number of at least one guest user detected in the premises.

14. The apparatus according to claim 10, wherein the processor is further configured to:
disable a guest account when a guest user leaves the premises.

15. The apparatus according to claim 10, wherein the processor is further configured to:
disable all guest accounts when all known users leave the premises.

16. The apparatus according to claim 10, wherein said at least one guest account permits connection of a guest device to the local area network without prior registration or authentication.

17-18. (canceled)

19. The apparatus according to claim 10, wherein the apparatus is one of a gateway device and a router device.

20. (canceled)

21. A non-transitory computer-readable program product comprising program code instructions for performing the method according to claim 1 when the program is executed by a computer.
